(19) United States
(12) Patent Application Publication
(10) Pub. No.: US 2024/0221335 A1
(43) Pub. Date: Jul. 4, 2024

(54) MACHINE LEARNING FOR POSE ESTIMATION OF ROBOTIC SYSTEMS

(71) Applicant: Intrinsic Innovation LLC, Mountain View, CA (US)

(72) Inventors: Olivier Pauly, Munich (DE); Stefan Hinterstoisser, Munich (DE); Martina Marek, Munich (DE); Martin Bokeloh, Munich (DE); Hauke Heibel, Höhenkirchen-Siegertsbrunn (DE)

(21) Appl. No.: 18/534,478

(22) Filed: Dec. 8, 2023

Related U.S. Application Data
(60) Provisional application No. 63/436,372, filed on Dec. 30, 2022.

(51) Int. Cl. G06T 19/20; G06T 17/20

(52) U.S. Cl. CPC G06T 19/20; G06T 17/205; G06T 2207/20081; G06T 2207/20084; G06T 2210/12; G06T 2210/56; G06T 2219/2004; G06T 2219/2016; G06T 2219/2021

(57) ABSTRACT

Methods, systems, and apparatus, including computer programs encoded on computer storage media, for estimating a pose of an object of interest. One of the methods includes receiving an input including an image that represents a pose of an object, processing the image using a machine learning model to predict output for the image, based on the output from the machine learning model, determining a correspondence between pixels in the image and locations on a three-dimensional model of the object, and determining the pose of the object based on the correspondence. The input further includes pre-processing output after pre-processing data associated with the object. The determined pose are processed by a downstream module to generate an updated pose.

### CROSS-REFERENCE TO RELATED APPLICATIONS

This application claims priority to U.S. Provisional Application No. 63/436,372, filed on Dec. 30, 2022. The disclosure of the prior application is considered part of and is incorporated by reference in the disclosure of this application

### BACKGROUND

This specification relates to frameworks for estimating poses of one or more objects in robotic systems using machine learning techniques.

Robotic manipulation tasks often heavily rely on sensor data. For example, a warehouse robot that moves boxes can be programmed to use camera data to pick up a box at the entrance of a warehouse, move it, and put it down in a target zone of the warehouse. For another example, a construction robot can be programmed to use camera data to pick up a beam and put it down onto a bridge deck. The sensor data can be further use to estimate a pose of an object in the robotic system. However, pose estimation is generally challenging because errors and outliers can be introduced at different steps of processing the sensor data.

A robotic system can deploy one or more machine learning models, e.g., neural networks, to perform respective machine learning tasks. Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of network parameters. A neural network can include an autoencoder including an encoder and one or more decoders. The encoder is configured to generate features for input data and the one or more decoders are configured to generate corresponding outputs for the features.

### SUMMARY

This specification describes a system configured to estimate one or more poses of one or more objects in a robotic execution environment. More specifically, the system is configured to determine a pose of an object of interest from an input image. The determination process generally involves a pose transformation from a local coordinate system associated with the object of interest to a reference coordinate system (e.g., a camera coordinate, a robot coordinate, or a workcell coordinate, to name just a few examples).

In this specification, a pose for an object generally represents a location and an orientation of the object. For example, a pose can include values for one or more translational degrees of freedom (DOFs), and values for one or more rotational DOFs. A translational DOF can represent a position along the x, y, or z orthogonal axis in a suitable coordinate system (e.g., Cartesian coordinate system). A rotational DOFs can represent a rotation around the x, y, or z axis in a suitable coordinate system.

The term “execution environment” in this specification generally refers to an environment where one or more robots are performing actions along different trajectories following their respective motion plans to achieve goals. For simplicity, the term “robotic execution environment” is also referred to as an operational environment, a working environment, or a workcell.

The term “object” in this specification generally refers to a component in the execution environment. The object can include a robot performing a task, a robotic component of the robot (e.g., a robotic arm, joint, or an end-effector), an object in the execution environment (e.g., an item to be picked up by a robot, an obstacle that a robot should avoid, a sensor, or another object), and a reference item in the working environment (e.g., a working table or bench).

Techniques described in this specification can be implemented by a system including one or more modules. The system can include a pre-processing module, a pose estimation module, and a refinement module. The pre-processing module is configured to pre-process input data associated with an object of interest and generate pre-processing output data for the input data. The pose estimation module is configured to generate an estimated pose for the object after processing the pre-processing output and an input image capturing the object. The refinement module is configured to update the estimated pose for generating a refined or updated pose for the object.

The pre-processing module is configured to receive input data associated with an object of interest. The input data can include a three-dimensional model representing the object (e.g., a computer-aided design (CAD) model). The pre-processing module can include a mesh engine to process the three-dimensional model to generate a mesh for the object. The mesh can include multiple nodes (e.g., vertices generated from intersecting edges). The pre-processing module is further configured to determine or detect a level of symmetry of the object based on the generated mesh.

In some implementations, the pre-processing module can include a scanning engine with multiple sensors to scan data of the object. The scanned data can be processed by the scanning engine to generate the above-noted three-dimensional model.

To generate the mesh, the pre-processing module can modify the three-dimensional model. For example, the pre-processing module can round up sharp corners or edges using beveling techniques. The pre-processing module can further perform mesh smoothing techniques according to a predetermined smoothness level.

To detect a level of symmetry, the pre-processing module can determine whether the mesh of the object has a symmetry, and optionally, a type of symmetry. The types of symmetry can include a global symmetry such that the entire mesh is symmetric under a transformation, and a partial symmetry such that a part of the mesh is symmetric under another transformation.

In addition, the pre-processing module can implement different techniques for detecting symmetry. For example, the module can implement a feature-line-based technique. A feature line generally refers to a 3D object used as grading footprints, surface break lines, or corridor baselines. In the feature-line-based technique, the module can determine multiple pairs of feature lines from the mesh, sample two pairs of feature lines each defining a coordinate frame, determine a candidate transformation from a first coordinate frame defined by a first pair of the two pairs to a second coordinate frame defined by a second pair of the two pairs, and determine a level of overlap for the candidate transformation. The module can determine a symmetry for the mesh based on the level of overlap.

As another example, the module can implement a voting-based technique. In the voting-based technique, the module samples multiple transformations between different coordinate frames, and clustering the transformations in a transformation space to determine the symmetry. Generally, the largest cluster represents a dominant transformation, which can be used to determine the symmetry.

In some implementations, the module is configured to determine a sparse set of keypoints from the mesh. A keypoint is a point from a three-dimensional model or a node or vertex in a mesh of the three-dimensional model. The module can receive a mesh as input. In some cases, the module can receive a cloud of points for the three-dimensional model as input. A first example technique to determine keypoints can include a farthest point sampling technique. Another example technique for determining keypoints can include a curvature or slippage-based farthest point sampling. Both techniques are described in greater details below. Other example techniques for sparse keypoints extraction include using a multi-scale integral volume descriptor algorithm, the meshSIFT algorithm, multi-scale slippage features algorithm, or other suitable algorithms.

The pose estimation module can include a machine learning model to process the output from the pre-processing module and an input image capturing the object of interest with a particular pose. One example machine learning model can include a backbone network (e.g., a pre-trained network with multiple layers) and one or more heads for different tasks. Each head includes one or more layers appending the backbone network. The machine learning model is configured to process the input image and the pro-processing output to generate model output used for determining correspondences between points located on the 3D model of the object and the pixels in the input image capturing the object. The correspondences are also referred to as correspondence data or 2D-3D correspondences in the following description. The correspondences can be processed by the pose estimation module to generate an estimated pose for the object captured in the image.

The machine learning model can be configured to process sparse keypoints. As described above, the sparse keypoints can be determined from a mesh of the object by a pre-processing module. The machine learning model for sparse keypoints can include a two-stage keypoint regression model. In the two-stage model, the machine learning model can include a first stage network configured to generate a first output after processing the input image and the input sparse keypoints. The first output can include one or more candidate bounding boxes each enclosing the object in the images, and scores associated with the boxes. A second stage network in the machine learning model is configured to process at least a portion of the candidate bounding boxes to generate a second output. The second output can include a predicted class for each input bounding box, a respective score for each of the predicted classes, and one or more regressed keypoints associated with the locations on the three-dimensional model of the object.

The machine learning model for sparse keypoints can include a single-stage model. In the single-stage model, the machine learning model includes a single network having a backbone network and one or more additional convolution layers. The single-stage model does not need to pre-filter any intermediate results. Instead, the single-stage model can process the input image and sparse keypoints directly to generate model output. The model output can include a predicted class for each input bounding box, a respective score for each of the predicted classes, and one or more regressed keypoints associated with the locations on the three-dimensional model of the object.

In some implementations, the machine learning model can be used for processing dense keypoints. The term “dense keypoints” in this document generally refers to point clouds or vertices from the mesh without being processed by a sparse keypoint extractor. The machine learning model for dense sparse keypoints can generally include a multi-tasks neural network which is configured to generate multiple outputs after processing the same input. The output can include an object “centerness” defining a probability distribution of pixels representing a center of the object, a bounding box side-distance map defining a distance between a pixel in a bounding box and a side of the bounding box, segmentation classifications for pixels in the bounding box, and location fields for each pixel representing the object in the bounding box. A location field represents a three-dimensional location on the 3D model of the object for a corresponding pixel in the bounding box.

In some implementations, the machine learning model for dense keypoints can include an auto-encoder, which includes a single encoder for generating features after processing input data, and a single decoder for generating different types outputs for features. In some implementations, the machine learning model for dense keypoint can include a single encoder with multiple different decoders, and each decoder is configured to process respective features generated from the encoder to predict different types of outputs.

The machine learning model for dense keypoints can be trained using a signed version of Jaccard loss function, where the predicted location fields are normalized between −1 and 1, and the Jaccard loss function includes two terms, e.g., a first term representing positive prediction values with positive labels, and a second term representing non-positive prediction values with non-positive labels. The system can update model parameters of the machine learning model for dense keypoints by optimizing a corresponding objective function based on the signed version of Jaccard loss function.

In some implementations, the pose estimation module can include a refiner to refine the predicted correspondences. For situations where sparse keypoints are used, the pose estimation module is configured to include a subnetwork with one or more fully connected layers to generate refined keypoint locations and a respective score for keypoints for input keypoint locations. For situations where dense keypoints are used, the pose estimation module is configured to implement another convolutional auto-encoder, which is configured to project or map the correspondence predictions into a subspace of possible location field configurations, and generate refined keypoint location fields based on the mapping.

The refinement module in the system is configured to update or refine a pose predicted for an object of interest. In some implementations, the refinement module can include an edge-based registration engine configured to update the predicted pose by pairing, according to one or more criteria, image features of an input image and corresponding candidate features for the 3D model of the object. The module is configured to update the predicted pose based on the feature pairs. The image features can include gradients and magnitudes in multiple channels of the input image. The candidate features include one or more local maximum model gradients of multiple modalities. A modality can represent a normal vector, a color gradient, or a depth gradient determined based on the data representing the predicted pose of the object (e.g., the 3D model of the object). The one or more criteria can include an image feature being a local maximum in a gradient direction, a threshold difference in a direction between a candidate feature and an image feature, or a threshold difference in magnitude between an image feature and a maximum of the candidate feature along a search line.

The refinement module can further include a machine learning model for refining the predicted poses. The machine learning model for refinement can be added to the machine learning model for predicting correspondence data, and can be trained end-to-end. In other words, the machine learning model for sparse or dense keypoints are trained on the same training samples as the machine learning model for refinement. The machine learning model for refinement can receive predicted keypoints generated by sparse keypoints machine learning models. For dense keypoint machine learning models, the machine learning model for refinement can receive a subset of predicted location fields. The sparse keypoints and the location fields correlate a 2D pixel in an input image capturing the object with a 3D location on a surface of a 3D object model. The machine learning model for refinement also receives as input an initial pose determined using a particular algorithm. The model outputs a refined pose predicted for the object in the input image.

In some implementations, the refine module can receive input data from a set of feature channels. Each feature channel has a size of N for a corresponding keypoint. The model can assign a respective weight value to each of the multiple feature channels, and combine the input received from the multiple channels based on the respective weight values.

Particular embodiments of the subject matter described in this specification can be implemented so as to realize one or more of the following advantages. In sum, the described techniques improve the efficiency and accuracy for estimating a pose of an object of interest in an execution environment.

Regarding the efficiency, the described techniques can extract sparse keypoints from a mesh or a 3D model of the object. The extracted sparse keypoints requires less memory bandwidth for transmitting and processing than regular dense keypoints. The described techniques can include a machine learning model for processing the sparse points. Since machine learning models do not require an explicit expression for regression, the overall speed and performance for regressing keypoints to determine 2D-3D correspondence data are improved. In addition, the system can combine the machine learning model for sparse keypoints and a machine learning model for pose refinement as a model group, and train the model group end-to-end using the same set of training samples, which facilitates the training process and further improves the efficiency of pose estimation.

Regarding the accuracy, the described techniques can include one or more refinement processes to improve the accuracy of pose estimation. For example, the system can refine the 2D-3D correspondence data generated based on the machine learning model outputs, and use the refined 2D-3D correspondence data for estimating an initial pose (or a rough pose). The system can further implement a refinement module to update or refine the initial pose or rough pose using different techniques. Furthermore, the system can modify the 3D model of an object by eliminating sharp edges and corners to improve the mesh quality, which leads to an improvement in the accuracy of downstream operations. In addition, the machine learning models for processing dense keypoints can be trained using a signed version of Jaccard loss function, which can accurately capture losses generated by both negative and positive normalized field locations, and thus improve the inference accuracy. Moreover, the machine learning model for refinement and the machine learning model for processing keypoints can be trained end-to-end, which reduces the errors or inaccuracies introduced by intermediate outputs (e.g., correspondence data, keypoints, or initial poses).

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram that illustrates an example system.

FIG. 2 is a diagram that illustrates an example pre-processing module.

FIG. 3 is a flowchart of an example process for generating pre-processing output by a pre-processing module.

FIG. 4 is a diagram that illustrates an example pose estimation module.

FIG. 5 is a flowchart of an example process for estimating a pose of an object by a pose estimation module.

FIG. 6 is a diagram that illustrates an example refinement module.

FIG. 7 is a flowchart of an example process for refining a pose of an object by a refinement module.

FIG. 8 is a flowchart of another example process for refining a pose of an object by a refinement module.

FIG. 9 illustrates an example symmetry determined for a hexagonal nut.

FIG. 10 is a diagram that illustrates an example machine learning model for processing dense keypoints.

Like reference numbers and designations in the various drawings indicate like elements.

### DETAILED DESCRIPTION

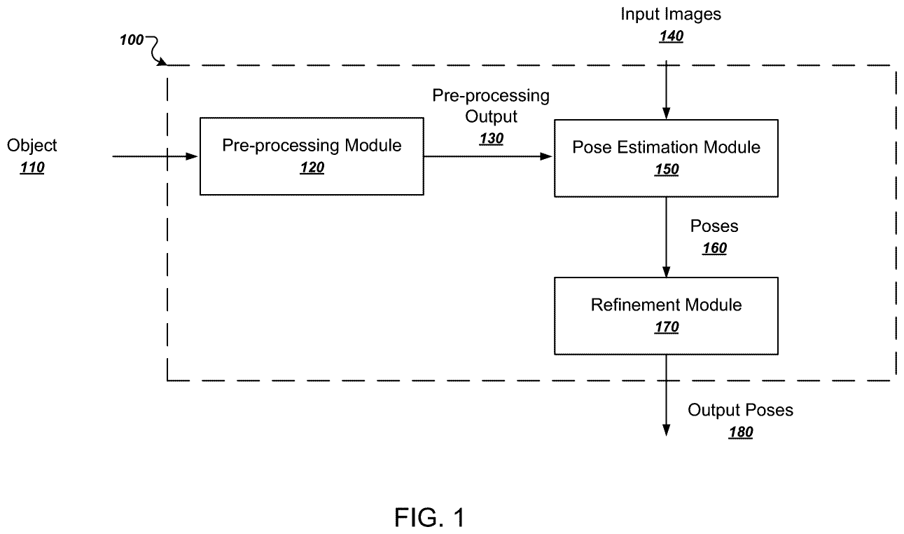

FIG. 1 is a diagram that illustrates an example system 100. The system 100 is an example of a system that can implement the techniques described in this specification. The example system 100 is a system implemented on one or more computers in one or more locations, in which systems, components, and techniques described below can be implemented. Some of the components of the system 100 can be implemented as computer programs configured to run on one or more computers.

In short, the system 100 is configured to estimate a pose for an object of interest captured in an image. The object of interest can include a robot or other components in an execution environment of a robotic system, including objects to be manipulated by a robot. System 100 can be included in a robotic system, but in some cases, the system 100 can be external to a robotic system. The system 100 can be generally used for other suitable systems, e.g., an autonomous driving system.

As shown in FIG. 1, the system 100 includes a pre-processing module 120, a pose estimation module 150, and a refinement module 170. The system 100 is configured to receive as input (i) an input image 140 capturing an object 110 of interest and (ii) data associated with the object 110. The object 110 captured in the image has a particular pose (e.g., in a particular position and orientation). The system 100 is configured to predict an output pose for the object 100 in the image 140 after processing the above-noted input.

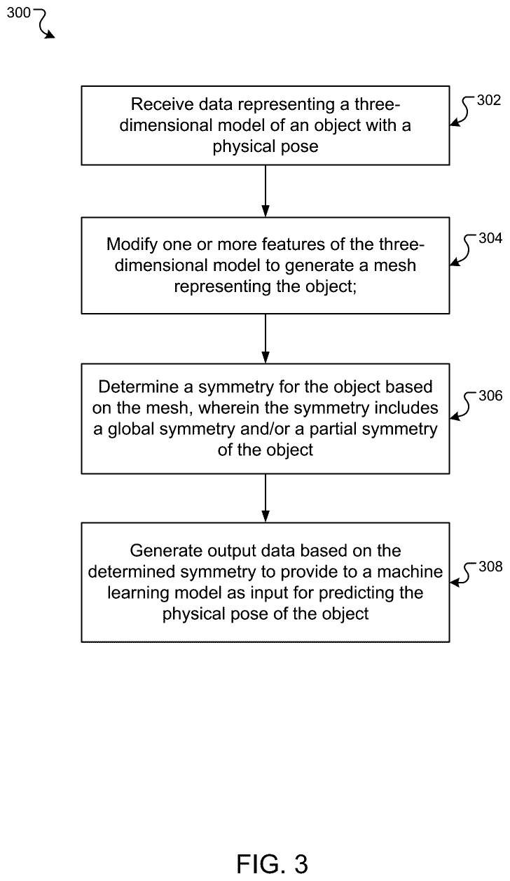

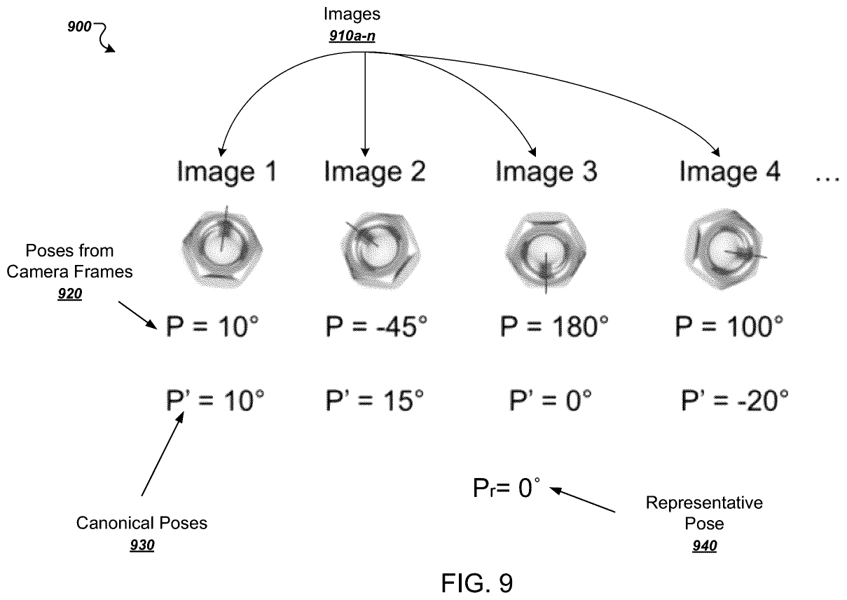

The pre-processing module 120 is configured to pre-process data associated with an object 110 of interest to generate pre-processing output 130. The data associated with the object can include a three-dimensional (3D) model of the object. In some cases, the pre-processing module 120 can be configured to generate data including a 3D model of the object by scanning the object 110. In addition, the pre-processing module 120 is configured to generate a mesh for the 3D model. The generated mesh is then processed by the pro-processing module 120 to determine a level of symmetry of the mesh. The pre-processing module 120 can implement different techniques to determine the level of symmetry. More details of determining the system level are described in connection with FIGS. 3 and 9.

In some cases, the pre-processing module 120 is further configured to determine a set of sparse keypoints (e.g., nodes, points, or vertices on the surfaces of the 3D model or the mesh) such that the size of the pre-processing output 130 is reduced, which further facilitates downstream operations. The module 120 can implement different techniques to extract sparse keypoints from the mesh. More details of extracting sparse keypoints are described in connection with FIG. 3.

The pre-processing output 130 can generally include data representing the mesh of the 3D model and the level of symmetry associated with the mesh. In some cases, the pre-processing output 130 can further include data representing a set of sparse keypoints extracted from the mesh.

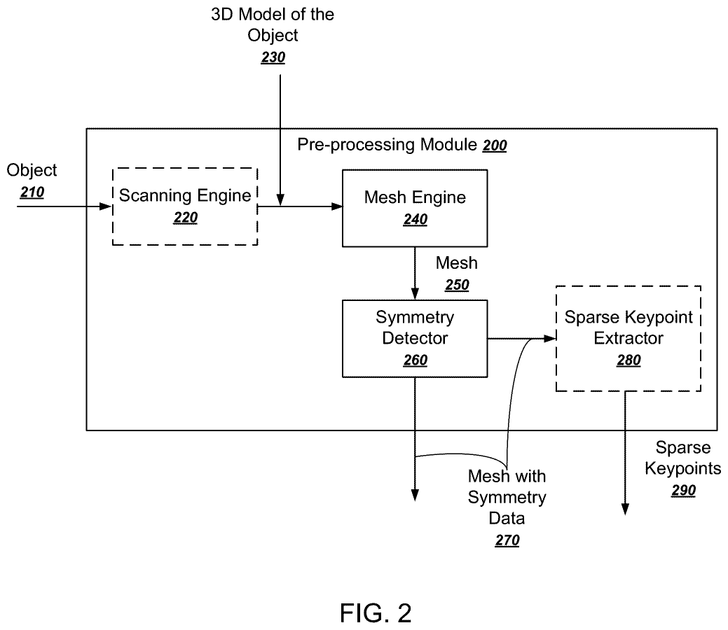

More details of the structure of the pre-processing module 120 are described in connection with FIG. 2, and example operations performed by the pre-processing module 120 are described in connection with FIG. 3.

The pose estimation module 150 is configured to process the pre-processing output 130 and an input image 140 capturing the object 110. Since the object 110 is captured in a particular pose in the input image 140, the pre-processing output 130 is configured to estimate the particular pose 160 shown in the input image 140.

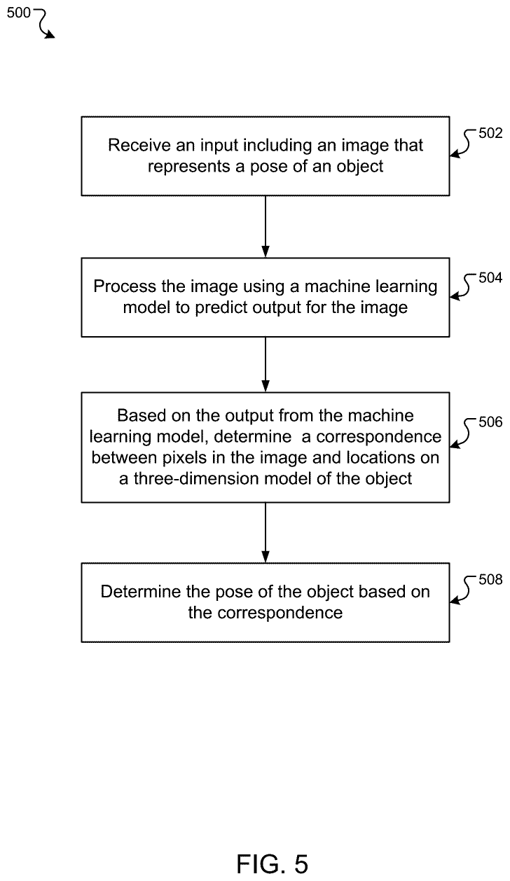

For different data in the pre-processing output 130, the pose estimate module 150 can include different types of machine learning models to process. For example, for pre-processing output including a set of sparse keypoints, the pose estimation module 150 can include a machine learning model trained to process sparse keypoints. The machine learning model for sparse keypoints can be configured differently using different techniques. For example, the machine learning model for sparse keypoints can include a two-stage keypoint regression model. As another example, the machine learning model for sparse keypoints can include a single-stage focal loss model. The machine learning model for sparse keypoints is configured to output one or more bounding boxes (also referred to as box in the following description for simplicity), one or more classification scores (also referred to scores) each associated with a bounding box), one or more regressed keypoints determined from the input sparse keypoints. The regressed keypoints can be used to determine correspondences between 2D pixels in the image and 3D keypoints (or 3D points, or 3D nodes, or 3D vertices) of the 3D model of the mesh. The correspondences can later be used to predict a pose for the object by the pose estimation module 150. More details of the machine learning model for sparse keypoints are described in connection with FIG. 5.

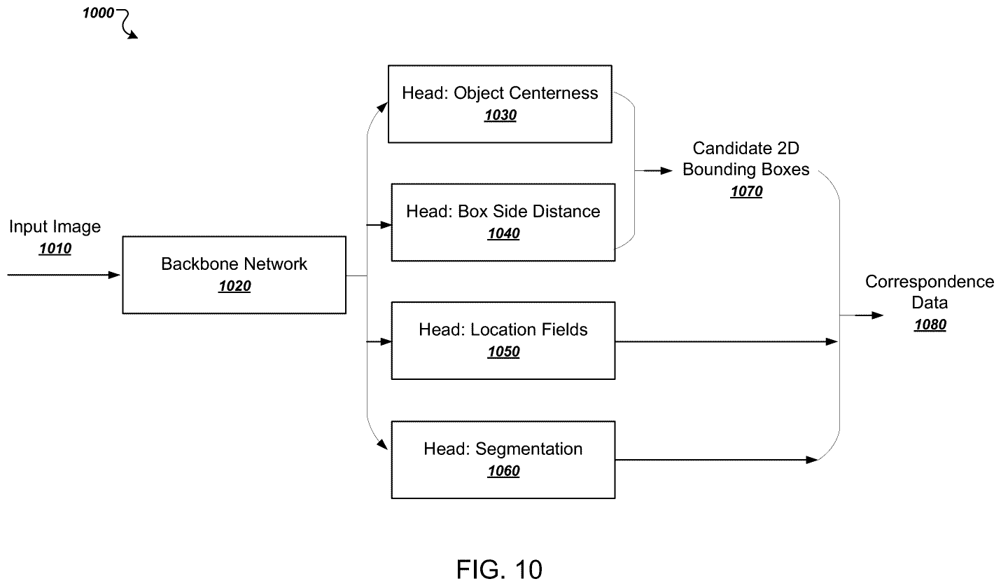

In some cases where in the pre-processing output 130 does not include sparse keypoints (or includes point clouds or nodes in the mesh), the pose estimation module 150 can include a machine learning model for processing dense keypoints. The machine learning model for dense keypoints is generally a multi-task machine learning that generates different types of outputs for the same input. More specifically, the machine learning model for dense keypoints can include a backbone network with one or more task heads. The backbone network includes a sequence of neural network layers with pre-trained model parameters. Each task head includes a respective sequence of network layers appending the backbone network. The different types of output can include a probability distribution for pixels being a center of the object of interest, a bounding box side distance between a pixel and an edge of the bounding box, a location field that represents a corresponding 3D position on the mesh or 3D model for a pixel in the image, and a segmentation classification for a pixel in the bounding box. These different types of outputs can be combined accordingly to determine correspondences between 2D pixels in the image and 3D keypoints (or 3D points, or 3D nodes, or 3D vertices) of the 3D model of the mesh. Similar to the sparse keypoint cases, the correspondences are processed through a particular algorithm to predict a pose for the object by the pose estimation module 150. More details of the machine learning model for dense keypoints are described in connection with FIGS. 5 and 10.

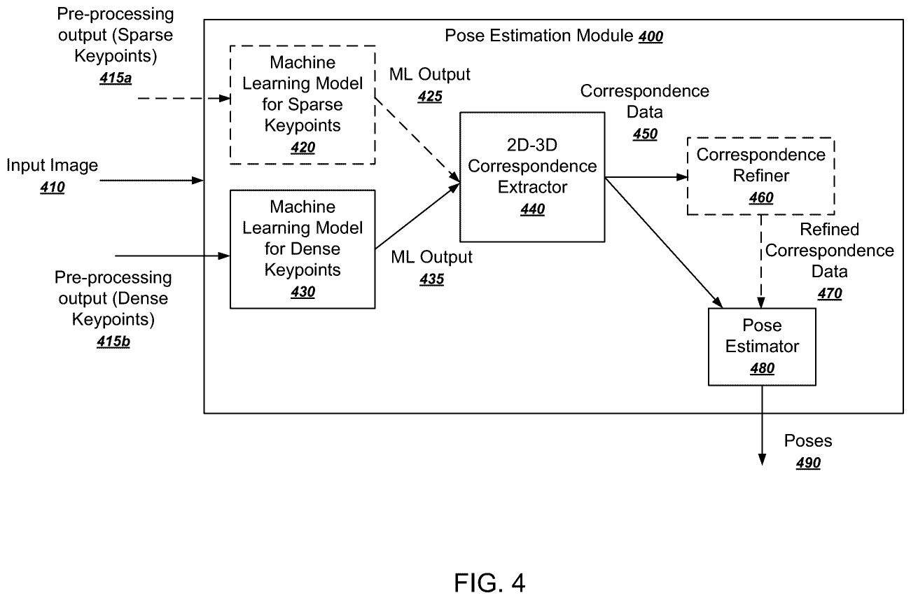

In some cases, the pose estimation module 150 can refine the 2D-3D correspondences predicted from the machine learning model such that noises and misconfigurations can be reduced or even eliminated. The pose estimation module 150 can estimate a pose with a higher level of accuracy by using the refined 2D-3D correspondences. More details of the refinement process for correspondences are described in connection with FIG. 5. In addition, a more detailed example structure of the pose estimation module 150 is described in connection with FIG. 4.

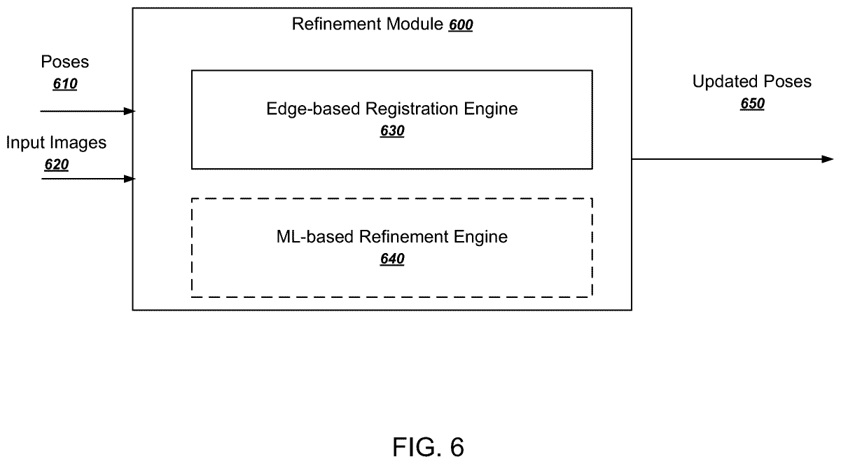

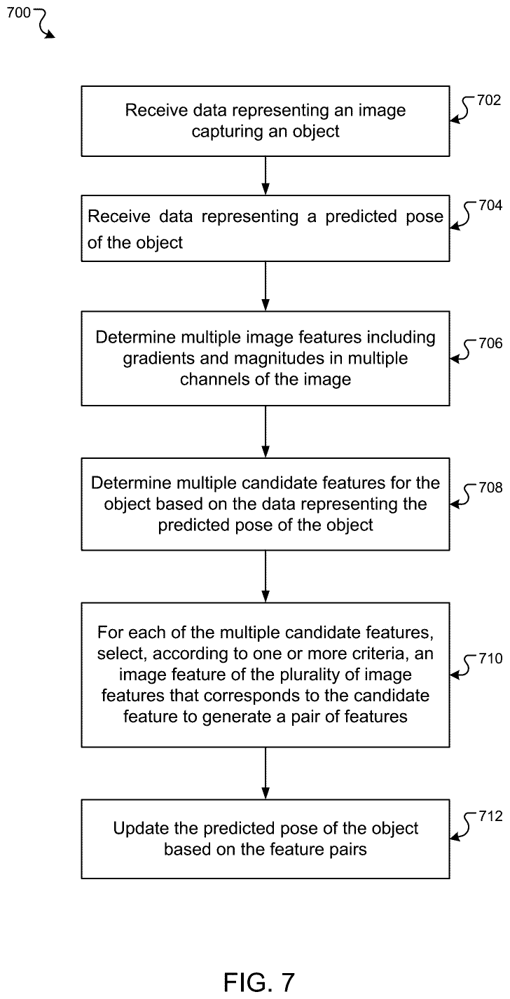

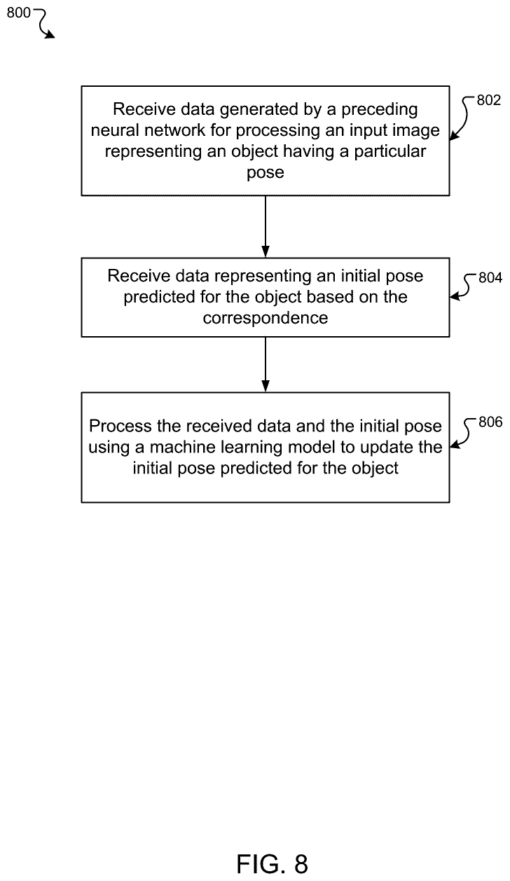

The refinement module 170 is configured to generate output poses 180 after refining or updating poses 160 generated by the pose estimation module 150. To refine a pose 160, the refinement module 170 can implement different techniques. For example, the refinement module 170 can include an edge-based registration technique to iteratively update a pose based on pairs of matched edges, each pair including an edge from the input image and an edge obtained from the 3D model or mesh of the object. As another example, the refinement module 170 can implement a machine learning model for refinement. The machine learning model can be combined with the machine learning model in the pose estimation module 150. The two models can be trained end-to-end using the same training examples. A detailed example structure of the refinement module 170 is described in connection with FIG. 6. The edge-based registration technique is described in greater detail in connection with FIG. 7, and the machine learning model for refinement is described in greater detail in connection with FIG. 8.

FIG. 2 is a diagram that illustrates an example pre-processing module 200. The pre-processing module 200 can be implemented on one or more computers in one or more locations. Some of the components of the pre-processing module 200 can be implemented as computer programs configured to run on one or more computers. The pre-processing module 200 is similar or equivalent to the pre-processing module 120 of FIG. 1.

As shown in FIG. 2, the pre-processing module 200 can receive data associated with an object 210. Data associated with the object 210 can include a 3D model of the object 230. The 3D model can include a computer-aided design (CAD) model. In some cases when a 3D model of the object 230 is not available, the pre-processing module 200 can scan a given object 210 using a scanning engine 220 to generate a 3D model of the object 230. The scanning engine 220 can include one or more cameras in the execution environment, an automated scanner, or a hand-held scanner. To construct a 3D model of the object 210, the scanning engine 220 is configured to collect sensor data representing multiple views of the object 210, and combine the collected sensor data to generate the 3D model. Example techniques for generating a 3D model from sensor data can include the Truncated Signed Distance Function (TSDF), the Shape Carving algorithm, the Neural Radiance Fields (NeRfs) technique, and the Point Cloud Merging algorithm.

In some cases, the sensor data can include texture data representing a texture of an object, and, optionally, material data representing the material of the object. Texture data and material data can render the 3D model more realistic and accurate. In addition, the sensor data (e.g., photos of different views) for the object can be labeled with respective poses. The labeled sensor data can be used for augmenting the training examples for training a machine learning model for predicting poses of objects. Furthermore, the scanning engine 220 can be configured to scan multiple different objects in the same class (e.g., a robot arm of different shapes and sizes). The system can provide the scanned objects as training examples to improve the robustness of the machine learning model.

The pre-processing module 200 can include a mesh engine 240 configured to generate a mesh 250 for the object after processing the 3D model of the object 230. However, existing techniques to generate mesh from a 3D model can encounter issues. For example, if the 3D model is an idealized representation of a physical object, directly rendering the idealized 3D model can lead to a significant discrepancy between the rendered image and the physical object. For example, sharp edges and corners in the idealized 3D model can disappear in the rendered images. To improve the accuracy of the mesh, the mesh engine 240 or the pre-processing module 200 can implement different techniques. For example, the mesh engine 240 can implement a geometric pre-processing technique to the 3D model first before converting the model into a mesh. One example geometric technique can be “beveling,” which rounds sharp edges and smooths out high-frequency details. As another example, the mesh engine 240 can implement a mesh smoothing operation (e.g., a smoothing step in a suitable CAD tool). The mesh engine can generate multiple meshes for a 3D model increasing levels of smoothness, and select one mesh based on the mesh quality or other criteria. In addition, the mesh engine can introduce various deformations to the 3D model before generating a mesh for the 3D model.

The pre-processing module 200 further includes a symmetry detector 260 configured to detect a level of symmetry for the mesh 250. The symmetry detector 260 can combine the symmetry information with the mesh to output data representing the mesh with symmetry data 270. By considering the symmetry in predicting a pose, the described techniques improve accuracy of training and using a machine learning model to predict a pose of an object, because an object with symmetry can introduce ambiguity in predicting object poses. For the purpose of this document, a symmetry or a symmetry transformation generally refers to a transformation that maps a part of the mesh onto another part of itself. The overlapped part is considered symmetric under the symmetric transformation. If there exists a particular transformation such that an entire mesh is symmetric, the mesh and the object are said to have a global symmetry, and the particular transformation is called a global symmetry transformation. If there exists a particular transformation such that only one or more parts (large or small) of a mesh are symmetric (overlapping), the mesh and the object are said to have a partial symmetry, and the particular transformation is called a partial symmetry transformation. To improve the accuracy of pose estimation, the described techniques are beneficial in detecting large partial or global symmetries since they are most likely to introduce ambiguity in training and using a machine learning model.

The symmetry detector 260 is configured to implement different techniques to determine large partial symmetries or global symmetries using different techniques. An example technique can be a feature-line based technique. Another example technique can be a voting-based technique. The details of the two example techniques are described in connection with FIG. 3. And the process for using the symmetry for pre-processing training examples for training a machine learning model is described in greater detail in connection with FIGS. 3 and 9.

In some cases, the pre-processing module 200 can include a sparse keypoint extractor 280 configured to generate a set of sparse keypoints after processing the mesh with symmetry data 270. To predict or estimate a pose for the mesh, the system can implement a machine learning model. The machine learning model can be trained to process keypoints (e.g., the sparse keypoints) for predicting a couple of keypoints. The term “keypoints” (also referred to as nodes, vertices, point clouds) generally represent 3D locations of the object captured in the input image. By generating and using sparse keypoints in the downstream pose estimation, the system improves the efficiency and reduces computation resources for the pose estimation.

One example algorithm for generating a set of sparse keypoints from an input mesh can be the farthest point sampling algorithm. In this algorithm, the sparse keypoint extractor 280 is configured to select a first point on the mesh surface, and iteratively select a next point that is farthest away from all previously-selected points on the mesh surface. The algorithm stops at a stopping point (e.g., a desired number of points are selected). The desired number can be 5, 10, 20, 50, or other suitable number of points.

Another example algorithm for generating a set of sparse keypoints from an input mesh can be the curvature-based or slippage-based farthest point sampling algorithm. In this algorithm, the sparse keypoint extractor 280 first computes a per-point vector describing the local geometry in the vicinity of the point. For example, a surface curvature (e.g., a minimum principal curvature, a maximum principal curvature, or a mean curvature) around the point is determined. As another example, measures defining how well a neighborhood local to the point would be constrained can be determined using the Iterative Closest Point (ICP) algorithm. The measure is also referred to as the slippage, which can be formulated as a 6-dimensional vector.

Based on the above-described curvatures or slippages, the sparse keypoint extractor 280 is configured to generate a metric measuring the “saliency” of a point. The saliency generally represents how interesting the point is, and interesting points are more likely to be included in the output sparse keypoints. The curvatures used to determine the “saliency” can include the absolute mean curvature, the absolute maximum principal curvature, or the absolute minimum principal curvature.

Unlike the above-described farthest point sampling algorithm, here the extractor 280 implements a new distance metric, e.g., expressed as follows:

$$D ( point 1 , point 2 ) = {L}_{2} ( point 1 - point 2 ) + {L}_{2} ( property 1 - property 2 ) \times factor 1 + saliency \times factor 2. \qquad Equation ( 1 )$$

In Equation (1), point 1 and point 2 represent a location of two different points, and function D(*) is the distance metric. The first term measures the geometric distance used in the above-described farthest point sampling algorithm. The second term measures the dissimilarity between two points weighted by a factor, and the third term uses the above-described saliency multiplied by another weight factor. The algorithm determines a next point (e.g., point 2) which generates the highest output from the D(*) function for all previously-selected points (e.g., point 1).

In some implementations, the sparse keypoint extractor 280 can implement other algorithms, e.g., the multiscale integral volume descriptor algorithm, the meshSIFT algorithm, the multi-scale slippage features algorithm, to name just a few examples.

FIG. 3 is a flowchart of an example process 300 for generating pre-processing output by a pre-processing module. For convenience, the process 300 can be performed by a pose estimation system of one or more computers located in one or more locations. For example, a system 100 of FIG. 1 or a pre-processing module 120 of FIG. 1, appropriately programmed, can perform the process 300.

The system receives data representing a three-dimensional model of an object with a physical pose (302). As described above, the 3D model of the object can be a CAD model. In some cases where the 3D model is not available, the system can scan the physical model to construct a 3D model for the object. To construct, the system can collect sensor data from different views of the object and implements various techniques to determine the 3D model based on the sensor data. The sensor data can include multiple images taken for the object from different perspectives. More details of generating the 3D model are described above in connection with FIG. 2.

The system modifies one or more features of the three-dimensional model to generate a mesh representing the object (304). To modify the one or more features, the system can use beveling techniques to round sharp edges or corners. Alternatively or in addition, the system can implement a smoothing technique to smooth the mesh to generate visually important edges in the mesh for training and using a machine learning model to estimate an object pose.

The system determines a symmetry for the object based on the mesh (306). The symmetry includes a global symmetry and/or a partial symmetry of the object. To determine a partial symmetry or a global system, the system can implement different algorithms. A first example algorithm can be the feature-line based algorithm. Another example algorithm can be the voting-based algorithm.

In the feature-line based algorithm, the system first extracts feature lines from the mesh geometry and generates multiple pairs of feature lines by sampling two adjacent, non-parallel feature lines into a feature line pair. A feature line generally refers to a 3D object used as grading footprints, surface break lines, or corridor baselines. Each pair of feature lines uniquely defines a coordinate frame. The system further samples two pairs of the feature line pairs, and generates a candidate transformation from the first coordinate frame defined by the first pair of the two pairs to the second coordinate frame defined by the second pair of the two pairs. The system further determines a respective overlap measure for the candidate transformation. The sampling and determining processes are performed repetitively. Based on the sampled pairs and overlap measures, the system determines a level of symmetry with respect to a rotational axis. For example, a greater overlap measure has a higher level of symmetry.

To facilitate the process of computing the overlap measures, the system can first compare each sparse feature line under the candidate transformation against the sparse feature line using a point-to-line distance. The system can reject false positive symmetries based on the point-to-line distances before computing overlap measures for all other feature lines in the entire mesh surface.

In the voting based algorithm, the system first samples random locations in the mesh to extract a coordinate frame where a normal direction and a tangential direction can be obtained. The tangential direction can be obtained based on local curvature analysis. The coordinate frame can be formed by the normal direction and the tangential direction. From all coordinate frames. the system generates a set of sampling pairs (e.g., based on a random selection). Each sampling pair in the set includes a pair of coordinate frames associated with the pair of sampled locations. For each sampling pair of the set of sampling pairs, the system determines a pose transformation from a first coordinate frame in the pair to a second coordinate frame in the pair. The system accumulates these transformations in a voting scheme such that the actual symmetry transformations can accumulate more occurrences (or votes). The system extracts dominant transformations using the mean shift clustering techniques in the transformation space to determine the level of symmetry for the object with respect to a rotational axis. In some implementations, the system can determine the sampled locations based on a surface descriptor, and each sampling pair can be determined based on a level of compatibility between the corresponding surface descriptors.

In addition, the symmetry determined by the system is visible from the current view of the mesh and can change when the viewpoint changes. The above-described symmetry are thus also referred to as view-point dependent symmetry. The viewpoints are sampled using different sampling methods (e.g., icosahedron sampling), and the above-described symmetry determination algorithms are applied to visible surfaces in corresponding viewpoints.

The system generates output data based on the determined symmetry (308). In some implementations, the system determines multiple sparse keypoints for the object based on the mesh for the object. To determine the sparse keypoints, the system can use the farthest point sampling algorithm or the curvature/slippage-based farthest point sampling algorithm, as described above. In the two algorithms, the system can sample a point as a keypoint from the mesh based on a distance measure between the point and a previously-sampled keypoint. In the latter algorithm, the system samples a point as the keypoint from the mesh based on a vector specifying a local geometry for the point, e.g., the local curvature or slippage. The vector for curvature can be used to determine a level saliency for the point. More details of the process of generating a set of sparse keypoints are described above in connection with FIG. 2.

As described above, the output data generated by the system are provided to a machine learning model as input for predicting the physical pose of the object. Also, the output can be used as training samples to train the machine learning model. The training samples improve the efficiency and robustness for training the machine learning model because the output data include meshes with determined symmetry information.

Instead of using an actual pose of an object, the system uses a canonical pose of the object captured in images as ground truth pose to train the machine learning model. The term canonical pose is also referred to as ground truth pose. The term “actual pose” generally refers to a pose of an object captured in an image, which is also referred to as an object pose, a physical pose, a pose from a camera frame, or simply a pose. The images for training are two-dimensional images generated from the mesh or 3D model of the object. Each of the training examples includes an image representing a pose of the object in the image and a ground-truth label for the pose.

Let P be the pose of an object in the camera frame, and let Ti be a symmetry transformation (also referred to as a symmetry generator, e.g., a rotation transformation that renders the rotated object overlap the object in the original state). An object can have multiple symmetry generators, e.g., {T₁, T₂, . . . , Tₙ}, which can further formulate a symmetry group, G={T₁ⁱ^{₁}×T₂ⁱ^{₂}× . . . ×Tₙⁱ^{ₙ}|i₁, i₂, . . . , iₙ ∈Z}, where the power term represents a number of Ti transformations applied.

As a naïve example, a hexagonal nut 900 in FIG. 9 has rotational symmetry around a central axis depicted in a solid line. The hexagonal nut 900 has one symmetry generator, which can be named as)“Rot_{z}(60°,” which represents a rotation of 60 degrees around the z-axis.

$${Rot}_{z} ( 60 ° ) = Identity , {{Rot}_{z} ( 60 ° )}^{1} , {{Rot}_{z} ( 60 ° )}^{2} , {{Rot}_{z} ( 60 ° )}^{3} , {{Rot}_{z} ( 60 ° )}^{4} , {{Rot}_{z} ( 60 ° )}^{5} .$$

This actually generates a group of 6 equivalent transformations: To determine a ground-truth label for a pose of the object in an image of the two-dimensional images, the system first determines one or more symmetry generators for the object, as described above. The system then determines a representative pose of the object (e.g., the identity transformation). The representative pose P_{T} can be the identity transformation. In some case, a representative pose P_{T} can be determined based on an orientation of a center of the object and an orientation of a center of a viewer or a sensor. For example, a representative pose P_{T} can be a pose where the array connecting a camera center and the object center always aligns with the array.

The system determines a pose generated from one of the multiple system generators that is mostly aligned with the representative pose as a canonical pose P′ of the object. The system labels the canonical pose P′ as the ground truth poses for the object after considering the symmetry.

Referring back to the above-noted hexagonal nut example and as shown in FIG. 9, a camera can take different images (e.g., images 910a-n) capturing the nut from different viewpoints. The poses from camera frames 920 can include P=10°, P=−45°, P=180°, P=100°, or other poses. Since the symmetry generator is a multiple of 60°, and the representative pose 940 is the identity (i.e., P=0°), the canonical poses 930 for these poses in the images 910a-n are accordingly P′=10°, P′=15°, P′=0°, P′=−20°.

Considering the symmetry in training and using a machine learning model is beneficial and can improve the accuracy of pose estimation. Taking the above-described hexagonal nut example, a pose of zero degree should look substantially identical to a pose of 120 degree. However, the loss function treats the two poses as different poses and considers a “prediction error” if a pose of zero degree is predicted as a pose of 120 degree. The “prediction error” contributes to the total loss generated by the loss function, and is propagated in the backward projection process, leading to noises in gradients and inaccurate model parameters. A10. The method of claim A9, wherein the representative pose of the object according to the symmetry is determined based on an orientation of a center of the object and an orientation of a center of a viewer.

FIG. 4 is a diagram that illustrates an example pose estimation module 400. The pose estimation module 400 can be implemented on one or more computers in one or more locations. Some of the components of the pose estimation module 400 can be implemented as computer programs configured to run on one or more computers. The pose estimation module 400 is similar or equivalent to the pre-processing module 150 of FIG. 1.

As shown in FIG. 4, the pose estimation module 400 is configured to process input including (i) the pre-processing output 415a or 415b and (ii) the input image 410 capturing the object with a particular pose, and generate estimated poses 490 after processing the input.

The pose estimation module 400 can include a machine learning model (420 or 430) for processing the above-noted input to generate machine learning output (425 or 435). More specifically, for implementations where a pre-processing module (e.g., the pre-processing module 120 of FIG. 1) includes a sparse keypoint extractor (e.g., the sparse keypoint extractor 280), the pose estimation module 400 can be configured to include a machine learning model for sparse keypoints 420 to process the input image 410 and the pre-processing output 415a including the sparse keypoints. For implementations where a pre-processing module does not include a sparse keypoint extractor, the pose estimation module 400 is configured to include a machine learning model for dense keypoints 430 to process the input image 410 and the pre-processing output 415b including the dense keypoints.

The system can use different techniques to implement the machine learning model for sparse keypoints 420 and the machine learning model for dense keypoints 430. Details of the machine learning model are described below in connection with FIG. 5.

The machine learning output 425 or 435 include one or more bounding boxes, one or more classifications or scores associated with bounding boxes. The machine learning output 425 includes one or more regressed keypoints for generating the 2D-3D correspondence data, and the machine learning output 435 includes location fields for generating the 2D-3D correspondence data.

The pose estimation model 400 can further include a 2D-3D correspondence extractor 440 for processing the machine learning output (425 or 435) to generate correspondence data 450, which correlates a pixel of an object captured in the input image 410 to a keypoint on a surface of a mesh or a 3D model of the object.

The pose estimation module 400 further includes a pose estimator 480 configured to process the correspondence data 450 to generate a pose 490 for the object in the input image 410. For example, the pose estimation module 400 can estimate a pose with 6 DOFs using the Perspective N Point (PNP algorithm) to process the 2D-3D correspondence data. TO improve the accuracy, the pose estimation module 400 can implement techniques to filter outlier data. For example, the pose estimation module 400 can implement the random sample consensus (RANSAC) algorithm to filter outliers. In this algorithm, random subsets of 2D-3D correspondence data are used to estimate the object pose, which accordingly consolidates the valid correspondences and filters outliers.

In some implementations, the pose estimation module 400 can further include a correspondence refiner 460 to refine the correspondence data 450 before using the correspondence data 450 to estimate a pose. The correspondence refiner 460 can implement different techniques for sparse keypoints and dense keypoints.

For cases where the 2D-3D correspondence data 450 are generated using sparse keypoints, the correspondence refiner 460 can include a subnetwork with one or more fully connected layers. The subnetwork can process the initially-predicted keypoints on the 3D model and generate refined keypoints each associated with a keypoint-specific score. In some cases, the refiner 460 does not regress the refined keypoints, instead, the refiner 460 regresses one or more offsets or residuals between the initially-predicted keypoints and the refined keypoints.

For cases where the 2D-3D correspondence data 450 are generated using dense keypoints, the correspondence refiner 460 can include a convolutional autoencoder. The autoencoder is configured to project the initially-predicted dense keypoints (or location fields) into a feature space (e.g., a subspace of possible location field configurations), and reconstruct the refined dense keypoints from the projected dense keypoints. This way, the refiner 460 can de-noise the initially-predicted dense keypoints or location fields.

FIG. 5 is a flowchart of an example process 500 for estimating a pose of an object by a pose estimation module. For convenience, the process 500 can be performed by a pose estimation system of one or more computers located in one or more locations. For example, a system 100 of FIG. 1 or a pose estimation module 150 of FIG. 1, appropriately programmed, can perform the process 500.

The system receives an input including an image that represents a pose of an object (502). The input data further includes a pre-processing output generated from a pre-processing module. The pre-processing output can include a set of sparse keypoints generated from a 3D model of an object, or data representing a mesh of the object. In some cases, the input further includes data representing a level of symmetry of the object.

The system processes the image using a machine learning model to predict output for the image (504). The system can implement a different machine learning model for different types of input.

For input data including a set of sparse keypoints, the system can implement a machine learning model for processing the sparse keypoints. For example, the machine learning model for sparse keypoints can include a two-stage keypoint regression model. An example two stage model can include a first neural network in the first stage. The first neural network can include a backbone convolutional neural network (CNN) for processing the input image and the sparse keypoints to generate a first output. The first output includes one or more candidate bounding boxes for the object in the input image and corresponding scores (also referred to as objectness scores) each associated with a corresponding bounding box. The first neural network can include, for example, a ResNet, an InceptionResNet, an Efficient Net, or other suitable backbone networks. In some cases, the first neural network can process data generated from the input image, for example, a pre-processed version of the input image containing a color gradient map or a color magnitude map.

The two-stage model further includes a second neural network in the second stage. The second neural network can include another CNN for processing a portion of the bounding boxes generated by the first neural network to generate classification data for the bounding boxes, scores associated with the bounding boxes, a refined axis aligned bounding box, and regressed sparse keypoints. The portion can be determined according to the scores associated with the bounding boxes. For example, the portion can include a list of bounding boxes with top N scores.

The system can implement the Focal Loss function for training the second neural network. The training using the focal loss function does not need the strict requirement of well-sampled training sets, which improves the training efficiency. In some implementations, the input images for training can be set to have a stride of 16. The input images can include RGB images, RGD(-D) images, pre-processed versions of the input images with different modalities, or other suitable types of input images or data derived from input images.

In other cases, the system can implement a single stage focal loss keypoint model for processing sparse keypoints. Unlike the above described two-stage model, the single-stage model includes only one neural network. The single-stage model can include a backbone network (e.g., a particular type of the InceptionResnet), and one or more convolutional layers. The one or more convolutional layer can include a shared layer having 512 channels. For each type of model output, the single-stage model can further include an additional convolutional layer having a depth of 512 and a respective output layer. All hidden layers in the single-stage model can include RELU activation functions for nodal operations. The different outputs generated by the single-stage model can include one or more bounding boxes, one or more classification scores associated with the bounding boxes, and regressed keypoints. The single-stage model is generally more efficient than the two-stage model because the outputs can be directly computed without filtering intermediate results.

To train the single-stage model, the system can implement the focal loss function for the classification scores, which can effectively handle non balanced training sets (thus no need for generating well-sampled training sets). For bounding boxes and keypoints, the system can implement a modified version of Faster-RCNN loss. More specifically, the system encodes ground truth keypoints with respect to predicted bounding boxes to compute the keypoint loss, instead of encoding ground truth keypoints with respect to ground truth bounding boxes or anchors. In some implementations, the input images are set to have a stride of 32 for backbone layers. Furthermore, the single-stage model can also process different types of input images, such as RGB images, RGB(-D) images, pre-processed versions of input images, or other suitable images or data derived from images.

For input data including dense keypoints, the system can implement a machine learning model to process dense keypoints. In general, the machine learning model for dense keypoints can include a multi-task convolutional neural network (CNN). The multi-task convolution neural network can include a backbone neural network with multiple tasks heads. The backbone network can include an autoencoder or a Unet. The autoencoder can be implemented to include an encoder for processing input data to generate features in a feature space, and a single decoder to decode the features. The decoder is coupled to multiple task heads assigned for different outputs. Alternatively, the autoencoder can be implemented to include a single encoder and multiple decoders each for decoding features for a respective task head.

A task head generally refers to one or more network layers appending the backbone network and specialized for generating a particular type of output data. For example, the task heads for the implemented multi-task CNN can include a first task head for predicting an object “centerness,” which can include a probability distribution of image pixels being a center of the object of interest. The multi-task CNN can include a second task head for predicting a distance between a pixel and an edge of a bounding box. A third task head included in the multi-task CNN can be configured to predict location fields of image pixels in the bounding boxes. Each location field encodes a 3D coordinates of a keypoint on a mesh surface or a 3D model surface of the object with an image pixel. One additional task head can be configured to predict segmentation-wise classification for image pixels such that each pixel can be classified whether it belongs to the object of interest. In some implementations, the additional task head can be implemented as a segmentation mask (e.g., a matrix with trained parameters).

To train the multi-task CNN, the system can implement a signed version of Jaccard loss function Lₛ(*) as follows:

$${L}_{s} ( y , {y}^{′} ) = 0.5 \times L ( y \geq 0 , {y}^{′} \geq 0 ) + 0.5 \times L ( y \leq 0 , {y}^{′} \leq 0 ) . \qquad Equation ( 2 )$$

Here, the term y represents ground truth labels for an output type, and the term y′ represents the predictions for the output type. The function L(*) refers to a smoothed version of Jaccard loss function, which is expressed below:

$$L ( y , {y}^{′} ) = 1 - 2 \times \frac{{\sum }_{n = 0}^{N} ( {y}^{′} \times y )}{{\sum }_{n = 0}^{N} ( y \times y + {y}^{′} \times {y}^{′} )} . \qquad Equation ( 3 )$$

The signed version of Jaccard loss function can improve the robustness and accuracy of the training process, because it allows the system to normalize location fields from −1 to 1.

One example machine learning model for dense keypoints 1000 is depicted in FIG. 10. As shown in FIG. 10, the machine learning model for dense keypoints 1000 can include a backbone network 1020 for processing the input image 1010. The backbone network 1020 can be coupled with multiple task heads. For example and as illustrated in FIG. 10, the backbone network 1020 is coupled with a first task head for object centerness 1030, a second task head for bounding-box side distance 2040, a third task head for location fields 1050, and a fourth task head for segmentation 1060. As described above, the backbone network 1020 can provide decoded features to the respective task heads for different types of output. The outputs from the first task head 2030 and second task head 1040 can be used to determine a set of candidate 2D bounding boxes 1070. And based on the candidate 2D bounding boxes 1070 and the outputs from the third head 1060 and the fourth head 1060, the system can determine 2D-3D correspondence data 1080 for estimating a pose of an object in the input image 1010.

Based on the output from the machine learning model, the system determines a correspondence between pixels in the image and locations on a three-dimensional model of the object (506). More specifically, when performing the inference operations of the trained multi-task CNN, the system can determine a set of candidate bounding boxes based on the output object “centerness” and the bounding-box side distances. More specifically, the system can obtain local maxima from the object “centerness” output layer (or channels) and distance information from the bounding-box side distance output layer (or channels) for determining the candidate bounding boxes. For each candidate bounding boxes, the system can use segmentation outputs and location fields to determine the 2D-3D correspondences. For examples, the system can compare segmentation outputs with a predetermined threshold value, and only pixels having segmentation outputs above the predetermined threshold value are candidates for determining potential correspondences. In some cases, the system can include median pooling layers to reduce outlier data. In addition or alternatively, the system can subsample the candidate 2D-3D correspondences to consolidate valid correspondences. The system determines the pose of the object based on the correspondence (508).

FIG. 6 is a diagram that illustrates an example refinement module 600. The refinement module 600 can be implemented on one or more computers in one or more locations. Some of the components of the refinement module 600 can be implemented as computer programs configured to run on one or more computers. The refinement module 600 is similar or equivalent to the refinement module 170 of FIG. 1.

As shown in FIG. 6, the refinement module 600 is configured to generate updated poses 650 for input poses 610 and input images 620. The refinement module 600 can include an edge-based registration engine 630 for refining the poses 610. In some implementations, the refinement module 600 can include a machine learning based refinement engine 640 to refine the poses 610.

For cases where the refinement module 600 includes an edge-based registration engine 630, the input poses 610 are updated iteratively by matching edges in the input poses 610 and corresponding edges in corresponding input images 620 at different scale levels. The edge-based algorithms implemented by the engine 630 are more robust to existing pose tracking algorithms as the edge-based algorithm does not need to obtain historic information of object poses (e.g., a pose for an object at a previous time step). In addition, the edge-based engine 630 is configured to compute multiple image features (e.g., multiple channel gradients and magnitudes) for an input image (e.g., an RGB input image capturing an object with a particular pose).

In each iteration step of multiple iteration steps, the engine 630 computes multiple candidate features for the object. The candidate features can include multiple local maxima model gradients of different modalities based on the keypoints of the object with a pose. The modalities can represent one or more of: a normal vector, a color gradient, or a depth gradient. The modalities can be determined based on the data representing the predicted pose of the object (e.g., a 2D image rendered from the keypoints of objects, or a mesh or 3D model of the object). The engine 630 can include respective weight values for different modalities based on a level of importance. For example, the engine 630 can assign a greater weight value for a modality with a higher importance and a smaller weight value for another modality with a lower importance. These local maxima model gradients are searched along a corresponding gradient direction.

Once the local maxima gradients are selected, the edge-based engine 630 is configured to search for a correspondence between the candidate features (e.g., local maxima gradients from the keypoints) and the image feature (e.g., the input gradients and magnitude images from the corresponding input image). A correspondence between a candidate feature and an image feature is found if one or more criteria are satisfied.

One example criterion can be whether a pixel in the generated magnitude image is also a local maximum in a corresponding gradient direction. The local maximum is determined among all pixels having similar gradient directions in the magnitude image. The gradient directions are similar if they are different by or below a threshold value. For example, the threshold value can be one degree, two degrees, five degrees, or other suitable threshold values. Another example criterion can be whether a corresponding gradient in the input gradients are roughly aligned with the model gradients determined from the rendered object. The two gradients are considered as roughly aligned if the discrepancy is less than or equal to another threshold value. The other threshold value can be one degree, two degrees, three degrees, or other suitable threshold values. Another example criterion can be whether the ratio between magnitude of the pixel in the magnitude map and the greatest local maxima magnitude along a search line satisfies a pre-determined threshold percentage. The pre-determined threshold percentage can include a 95%, 97%, 99%, or other suitable percentage.

In general, the engine 630 can select an image feature that satisfies all of the above-described criteria. However, in some cases, the engine 630 can select an image feature that mostly satisfies one or more of the above-noted criteria to match with a corresponding candidate feature. Once a candidate pair of features is matched, the engine 630 can compute a pose update in the Lie Space using the Lie algebra based on the candidate pair. The engine 630 can incorporate the predicted pose with the pose update to generate an updated pose. The engine 630 can repetitively perform the above-described operations to further update the updated pose in a next iteration step. The engine 630 stops the iterative process until it reaches a stopping point. The stopping point can include a threshold number of iterations or a threshold time period for iteration. In some cases, the stopping point can include a convergence threshold, and once an updated pose satisfies the convergence threshold, the engine 630 stops the refinement or update process.

The update scheme can be applied to different scales of an input image, and the scale values can be changed during the iteration process. For example, the engine 630 can first iteratively refine a pose for a small region of the object. After the updated pose in the small region satisfies a particular criterion, the engine 630 can increase the region size by a particular scale value (e.g., a value of two, three, five, or other suitable scale values) and further refine the pose for a larger region of the object. The scaling mechanism accordingly further facilitates the refinement process.

For cases where the refinement module 600 includes a machine learning based engine 640, the system can include an additional neural network to cooperate with the machine learning model for pose estimation. More specifically, the two machine learning models can be trained end-to-end using the same set of inputs, and the loss values are determined using the refined poses predicted by the neural network for refinement.

The machine learning model for refinement can receive as input the predicted keypoints or a subset of location fields generated from the machine learning model for pose estimation. Since the keypoints and the location fields encode 2D-3D correspondence data, the machine learning model can also receive 2D-3D correspondence data as input for some implementations.

The machine learning model for refinement can further receive as input an initial guess for the refined pose using the differential ransac (DSAC) algorithm. In some cases, the machine learning model for refinement can be incorporated with the Lie algebra for edge registration. Relevant Lie group operations can be implemented in a differentiable manner such as gradients for backpropagation can be computed for training the machine learning model.

In some cases, the machine learning model for refinement can receive a set of feature channels as input. Each keypoint of multiple keypoints can be assigned with N channels (N≥1). The engine 640 can assign different weight values to each of these feature channels based on a level of importance or stability. For example, the level of stability of feature channels in various conditions can be determined based on the regressed offset values in the 2D-3D correspondence refinement described above in connection with FIG. 5.

FIG. 7 is a flowchart of an example process 700 for refining a pose of an object by a refinement module. For convenience, the process 700 can be performed by a pose estimation system of one or more computers located in one or more locations. For example, a system 100 of FIG. 1 or a refinement module 170 of FIG. 1, appropriately programmed, can perform the process 700. In this case, the refinement module implements an edge-based registration algorithm.

The system receives data representing an image capturing an object (702). The object has a physical pose represented in the image. This pose is also referred to as an object pose or actual pose, as described above.

The system receives data representing a predicted pose of the object (704). The predicted pose can be generated using a machine learning model. The data can further include keypoints on a mesh or a 3D model of the object. In some cases, the system can further render the object based on the received data to generate 2D images that correspond to the received input image. The input image can include a RGB image.

The system determines multiple image features including gradients and magnitudes in multiple channels of the input image (706). The system further determines multiple candidate features for the object based on the data representing the predicted pose of the object (708). The multiple candidate features include one or more local maxima model gradients of multiple modalities. The multiple modalities can represent one or more of: a normal vector, a color gradient, or a depth gradient, determined based on the data representing the predicted pose of the object. More details of image features and candidate features are described above in connection with FIG. 6.

For each of the multiple candidate features, the system selects an image feature of the multiple image features that corresponds to the candidate feature according to one or more criteria (710). The selected image feature and the corresponding candidate feature are matched to generate a pair of features. The one or more criteria can include at least one of an image feature being a local maximum in a gradient direction, a threshold difference in a direction between a candidate feature and an image feature, or a threshold difference in magnitude between an image feature and a maximum of the candidate feature along a search line.

The system updates the predicted pose of the object based on the feature pairs (712). As described above, the system can iteratively update the predicted pose using the Lie algebra to process the pairs of features until a stopping point. In some cases, the system can implement a scaling factor to adjust the region size for updating the pose. More details are described above in connection with FIG. 6.

FIG. 8 is a flowchart of another example process 800 for refining a pose of an object by a refinement module. For convenience, the process 800 can be performed by a pose estimation system of one or more computers located in one or more locations. For example, a system 100 of FIG. 1 or a refinement module 170 of FIG. 1, appropriately programmed, can perform the process 800. In this case, the refinement module implements a machine learning based algorithm.

The system receives data generated by a preceding neural network for processing an input image representing an object having a particular pose (802). The output includes multiple keypoints or location fields associated with pixels in the input image. The keypoints or location fields encode the correspondence between the 2D pixels in the input image and three-dimensional coordinates of corresponding locations on a three-dimensional model of the object.

The system further receives data representing an initial pose predicted for the object based on the correspondence (804). The system processes the received data and the initial pose using a machine learning model to update the initial pose predicted for the object (806).

In some cases, the system receives the multiple keypoints or location fields from multiple features channels. Each keypoint or location field is assigned with multiple feature channels. The system can further assign a respective weight value to each of the multiple channels. Based on the weight values, the system can combine the input features received from the multiple feature channels based on the respective weight values.

The machine learning model for refinement can be trained end-to-end with the preceding neural network on the same training examples. The loss values are calculated based on the ground truth poses and the refined poses generated by the machine learning model for refinement. More details of the machine learning model for refinement are described in connection with FIG. 6.

Functionalities afforded by the software stack thus provide wide flexibility for control directives to be easily expressed as goal states in a way that meshes naturally with the higher-level planning techniques described above. In other words, when the planning process uses a process definition graph to generate concrete actions to be taken, the actions need not be specified in low-level commands for individual robotic components. Rather, they can be expressed as high-level goals that are accepted by the software stack that get translated through the various levels until finally becoming low-level commands. Moreover, the actions generated through the planning process can be specified in Cartesian space in a way that makes them understandable for human operators, which makes debugging and analyzing the schedules easier, faster, and more intuitive. In addition, the actions generated through the planning process need not be tightly coupled to any particular robot model or low-level command format. Instead, the same actions generated during the planning process can actually be executed by different robot models so long as they support the same degrees of freedom and the appropriate control levels have been implemented in the software stack.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method performed by one or more computers, the method comprising: receiving data representing a three-dimensional model of an object with a physical pose; modifying one or more features of the three-dimensional model to generate a mesh representing the object; determining a symmetry for the object based on the mesh, wherein the symmetry includes a global symmetry and/or a partial symmetry of the object; and generating output data based on the determined symmetry to provide to a machine learning model as input for predicting the physical pose of the object.

Embodiment 2 is the method of Embodiment 1, wherein the three-dimensional model of the object is a computer-aided design (CAD) model or generated based on a plurality of images of the object taken from different views.

Embodiment 3 is the method of Embodiment 1 or 2, wherein modifying the one or more features to generate the mesh comprises beveling or smoothing one or more sharp edges of the three-dimensional model.

Embodiment 4 is the method of any one of Embodiments 1-3, wherein determining the symmetry for the object based on the mesh comprises: determining multiple feature lines from the mesh, determining a set of pairs of feature lines from the multiple feature lines, wherein each pair of feature lines include two adjacent feature lines that are not parallel to each other so that the pair of feature lines uniquely define a coordinate frames, repeatedly sampling two pairs of feature lines from the set of pairs of feature lines, and for each two pairs, determining a candidate transformation from a first coordinate frame defined by a first pair of the two pairs to a second coordinate frame defined by a second pair of the two pairs; for each candidate transformation of the candidate transformations, determining a respective overlap measure for the candidate transformation; and determining the symmetry with respect to a rotational axis based on the respective overlap measures.

Embodiment 5 is the method of any one of Embodiments 1-4, wherein determining the symmetry for the object based on the mesh comprises: for each sampling of multiple samplings, determining a coordinate frame for multiple locations selected in the sampling; generating a set of sampling pairs from the multiple samplings, each sampling pair in the set includes a pair of coordinate frames associated with the pair of sampling; for each sampling pair of the set of sampling pairs, determining a pose transformation between the pair of coordinate frames; and clustering the pose transformations to determine the symmetry for the object with respect to a rotational axis.

Embodiment 6 is method of Embodiment 5, wherein each sampling is determined based on a surface descriptor, wherein each sampling pair of the set of sampling pairs is determined based on a level of compatibility between the corresponding surface descriptors.

Embodiment 7 is the method of any one of Embodiments 1-6, wherein the symmetry of the object is view-point dependent, which is visible from a current viewpoint.

Embodiment 8 is the method of any one of Embodiments 1-7, wherein training the machine learning model comprises: generating multiple two-dimensional images for the object based on the mesh as the plurality of training examples, wherein each of the training examples includes an image representing a pose of the object in the image and a ground-truth label for the pose, and providing the plurality of training examples to train a machine learning model.

Embodiment 9 is the method of Embodiment 8, wherein determining a ground-truth label for a pose of the object in an image of the multiple two-dimensional images comprises: determining multiple symmetry generators for the object; determining a representative pose of the object; determining, as a canonical pose of the object, a pose generated from one of the multiple symmetry generators that is mostly aligned with the representative pose, and labeling the canonical pose as the ground-truth label for the pose of the object.

Embodiment 10 is the method of Embodiment 9, wherein the representative pose of the object according to the symmetry is determined based on an orientation of a center of the object and an orientation of a center of a viewer.

Embodiment 11 is the method of any one of Embodiments 1-10, further comprising: determining multiple sparse keypoints for the object based on the mesh for the object.

Embodiment 12 is the method of Embodiment 11, wherein determining the multiple sparse keypoints for the object comprises: sampling a point as a keypoint from the mesh based on a distance measure between the point and a previously-sampled keypoint.

Embodiment 13 is the method of Embodiment 11, wherein determining the multiple sparse keypoints for the object comprises: sampling a point as the keypoint from the mesh based on a vector specifying a local geometry for the point, wherein the vector is used to determine a level saliency for the point.

Embodiment 14 is a system comprising one or more computers and one or more storage devices storing instructions that are operable, when executed by the one or more computers, to cause the one or more computers to perform respective operations of any one of claims 1-13.

Embodiment 15 is one or more non-transitory computer storage media encoded with a computer program, the program comprising instructions that are operable, when executed by data processing apparatus, to cause the data processing apparatus to perform respective operations of any one claims 1-13.

Embodiment 16 is a computer-implemented method comprising: receiving an input including an image that represents a pose of an object; processing the image using a machine learning model to predict output for the image; based on the output from the machine learning model, determining a correspondence between pixels in the image and locations on a three-dimensional model of the object; and determining the pose of the object based on the correspondence.

Embodiment 17 is the method of Embodiment 16, wherein the machine learning model comprises a two-stage neural network, comprising: a first neural network in a first stage, and a second neural network in a second stage after the first stage, wherein the first neural network is configured to receive as input the image and one or more sparse keypoints determined for the object in the image, and generate, for the image, an output including one or more candidate bounding boxes each with a predicted score; wherein the second neural network is configured to receive as input at least a portion of the one or more candidate bounding boxes, and generate output that, for the input to the second neural network, includes a predicted class for each input bounding box, a respective score for each of the predicted classes, and one or more regressed keypoints associated with the locations on the three-dimensional model of the object.

Embodiment 18 is the method of Embodiment 17, wherein at least the portion of the one or more candidate bounding boxes are sampled from the one or more candidate bounding boxes based on respective objective function scores.

Embodiment 19 is the method of any one of Embodiments 16-18, wherein the machine learning model comprises a single stage neural network, wherein the single stage neural network is configured to receive as input the image and one or more sparse keypoints determined for the object in the image, and is configured to generate output that, for the input image, includes at least a predicted class for each input bounding box, a respective score for each of the predicted classes, and one or more regressed keypoints associated with the locations on the three-dimensional model of the object.

Embodiment 20 is the method of any one of Embodiments 16-19, wherein the machine learning model comprises a multi-task neural network, wherein the multi-task neural network is configured to receive as input the image, and generate output that, for the input image, includes at least a probability distribution predicting a likelihood of a pixel in the input image being a center of the object, a predicted measure of distance from a pixel to a bounding box boundary, a location field encoding a relationship between a pixel and a three-dimensional coordinate of a corresponding location on a three-dimensional model of the object, and a segmentation mask encoding a likelihood of a group of pixels representing the object.

Embodiment 21 is the method of Embodiment 20, wherein the multi-task neural network includes an encoder for encoding the input image and a decoder for generating the output for the input image.

Embodiment 22 is the method of Embodiment 20, wherein the multi-task neural network includes an encoder for encoding the input image and multiple decoders each for generating a particular type of the output for the input image.

Embodiment 23 is the method of Embodiment 20, wherein the multi-task neural network has been trained by optimizing an objective function using training examples, wherein the objective function includes a signed version of Jaccard loss function.

Embodiment 24 is the method of any one of Embodiments 16-23, further comprising: optimizing the correspondence between the pixels in the image and the locations using a neural network having multiple fully connected layers to refine the locations on the three-dimensional model of the object.

Embodiment 25 is the method of any one of Embodiments 16-24, further comprising: optimizing the correspondence between the pixels in the image and the locations using a convolutional auto-encoder to refine the locations on the three-dimensional model of the objects.

Embodiment 26 is a system comprising one or more computers and one or more storage devices storing instructions that are operable, when executed by the one or more computers, to cause the one or more computers to perform respective operations of any one of claims 16-25.

Embodiment 27 is one or more non-transitory computer storage media encoded with a computer program, the program comprising instructions that are operable, when executed by data processing apparatus, to cause the data processing apparatus to perform respective operations of any one claims 16-25.

Embodiment 28 is a computer-implemented method, comprising: receiving data representing an image capturing an object, wherein the object has a physical pose represented in the image; receiving data representing a predicted pose of the object; determining a plurality of image features including gradients and magnitudes in multiple channels of the image; determining a plurality of candidate features for the object based on the data representing the predicted pose of the object; for each of the plurality of candidate features, selecting, according to one or more criteria, an image feature of the plurality of image features that corresponds to the candidate feature to generate a pair of features including the candidate feature and the selected image feature, and updating the predicted pose of the object based on the pairs of feature.

Embodiment 29 is the method of Embodiment 28, wherein the plurality of candidate features comprise one or more local maxima model gradients of multiple modalities

Embodiment 30 is the method of Embodiment 28 or 29, wherein the one or more criteria comprise at least one of: an image feature being a local maximum in a gradient direction, a threshold difference in a direction between a candidate feature and an image feature, or a threshold difference in magnitude between an image feature and a maximum of the candidate feature along a search line.

Embodiment 31 is the method of any one of Embodiments 28-30, wherein updating the predicted pose of the object based on the pairs of features comprises: determining an update for the predicted pose using Lie algebra to process the pairs of features.

Embodiment 32 is the method of any one of Embodiments 28-31, further comprising: repeatedly updating the predicted pose using one or more scale factors until a stopping point.

Embodiment 33 is the method of anyone of Embodiments 29-32, wherein the image is an RGB image, and the multiple modalities represent one or more of: a normal vector, a color gradient, or a depth gradient, determined based on the data representing the predicted pose of the object.

Embodiment 34 is a system comprising one or more computers and one or more storage devices storing instructions that are operable, when executed by the one or more computers, to cause the one or more computers to perform respective operations of any one of claims 28-33.

Embodiment 35 is one or more non-transitory computer storage media encoded with a computer program, the program comprising instructions that are operable, when executed by data processing apparatus, to cause the data processing apparatus to perform respective operations of any one claims 28-33.

Embodiment 36 is a computer-implemented method, comprising: receiving data generated by a preceding neural network for processing an input image representing an object having a particular pose to generate an output, wherein the output includes a plurality of keypoints or a plurality of location fields associated with pixels in the input image, wherein the plurality of keypoints or the plurality of location fields encode a correspondence between two-dimensional pixels in the input image and three-dimensional coordinates of corresponding locations on a three-dimensional model of the object; receiving data representing an initial pose predicted for the object based on the correspondence, and processing the received data and the initial pose using a machine learning model to update the initial pose predicted for the object.

Embodiment 37 is the method of Embodiment 36, wherein receiving the data generated by the preceding neural network comprising: receiving the plurality of keypoints or the plurality of location fields from multiple feature channels, each channel of the multiple feature channels for a respective keypoint or a location field.

Embodiment 38 is the method of Embodiment 37, further comprising: assigning a respective weight value to each of the multiple feature channels, and combining the plurality of keypoints or the plurality of location fields received from the multiple feature channels based on the respective weight values.

Embodiment 39 is the method of any one of Embodiments 36-38, wherein the machine learning model and the preceding machine learning model have been trained on a same set of training examples, wherein the training comprises optimizing a loss function defined based on refined poses predicted by the machine learning model.

Embodiment 40 is a system comprising one or more computers and one or more storage devices storing instructions that are operable, when executed by the one or more computers, to cause the one or more computers to perform respective operations of any one of claims 36-39.

Embodiment 41 is one or more non-transitory computer storage media encoded with a computer program, the program comprising instructions that are operable, when executed by data processing apparatus, to cause the data processing apparatus to perform respective operations of any one claims 36-39.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination.

Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain cases, multitasking and parallel processing may be advantageous.

What is claimed is:

1. A computer-implemented method for pre-processing a plurality of training examples used for training a machine learning model, comprising:
receiving data representing a three-dimensional model of an object with a physical pose;
modifying one or more features of the three-dimensional model to generate a mesh representing the object;
determining a symmetry for the object based on the mesh, wherein the symmetry includes a global symmetry and/or a partial symmetry of the object; and
generating output data based on the determined symmetry to provide to a machine learning model as input for predicting the physical pose of the object.

2. The method of claim 1, wherein the three-dimensional model of the object is a computer-aided design (CAD) model or generated based on a plurality of images of the object taken from different views.

3. The method of claim 1, wherein modifying the one or more features to generate the mesh comprises beveling or smoothing one or more sharp edges of the three-dimensional model.

4. The method of claim 1, wherein determining the symmetry for the object based on the mesh comprises:
determining multiple feature lines from the mesh,
determining a set of pairs of feature lines from the multiple feature lines, wherein each pair of feature lines include two adjacent feature lines that are not parallel to each other so that the pair of feature lines uniquely define a coordinate frames,
repeatedly sampling two pairs of feature lines from the set of pairs of feature lines, and for each two pairs, determining a candidate transformation from a first coordinate frame defined by a first pair of the two pairs to a second coordinate frame defined by a second pair of the two pairs;
for each candidate transformation of the candidate transformations, determining a respective overlap measure for the candidate transformation; and
determining the symmetry with respect to a rotational axis based on the respective overlap measures.

5. The method of claim 1, wherein determining the symmetry for the object based on the mesh comprises:
for each sampling of multiple samplings, determining a coordinate frame for multiple locations selected in the sampling;
generating a set of sampling pairs from the multiple samplings, each sampling pair in the set includes a pair of coordinate frames associated with the pair of sampling;
for each sampling pair of the set of sampling pairs, determining a pose transformation between the pair of coordinate frames; and
clustering the pose transformations to determine the symmetry for the object with respect to a rotational axis.

6. The method of claim 5, wherein each sampling is determined based on a surface descriptor, wherein each sampling pair of the set of sampling pairs is determined based on a level of compatibility between the corresponding surface descriptors.

7. The method of claim 1, wherein the symmetry of the object is view-point dependent, which is visible from a current viewpoint.

8. The method of claim 1, wherein training the machine learning model comprises:
generating multiple two-dimensional images for the object based on the mesh as the plurality of training examples, wherein each of the training examples includes an image representing a pose of the object in the image and a ground-truth label for the pose, and
providing the plurality of training examples to train a machine learning model.

9. The method of claim 8, wherein determining a ground-truth label for a pose of the object in an image of the multiple two-dimensional images comprises:
determining multiple symmetry generators for the object;
determining a representative pose of the object;
determining, as a canonical pose of the object, a pose generated from one of the multiple symmetry generators that is mostly aligned with the representative pose, and
labeling the canonical pose as the ground-truth label for the pose of the object.

10. The method of claim 9, wherein the representative pose of the object according to the symmetry is determined based on an orientation of a center of the object and an orientation of a center of a viewer.

11. The method of claim 1, further comprising:
determining multiple sparse keypoints for the object based on the mesh for the object.

12. The method of claim 11, wherein determining the multiple sparse keypoints for the object comprises:
sampling a point as a keypoint from the mesh based on a distance measure between the point and a previously-sampled keypoint.

13. The method of claim 11, wherein determining the multiple sparse keypoints for the object comprises:
sampling a point as the keypoint from the mesh based on a vector specifying a local geometry for the point, wherein the vector is used to determine a level saliency for the point.

14. A computer-implemented method comprising: receiving an input including an image that represents a pose of an object;
processing the image using a machine learning model to predict output for the image;
based on the output from the machine learning model, determining a correspondence between pixels in the image and locations on a three-dimensional model of the object; and
determining the pose of the object based on the correspondence.

15. The method of claim 14, wherein the machine learning model comprises a two-stage neural network, comprising:
a first neural network in a first stage, and
a second neural network in a second stage after the first stage,
wherein the first neural network is configured to receive as input the image and one or more sparse keypoints determined for the object in the image, and generate, for the image, an output including one or more candidate bounding boxes each with a predicted score;
wherein the second neural network is configured to receive as input at least a portion of the one or more candidate bounding boxes, and generate output that, for the input to the second neural network, includes a predicted class for each input bounding box, a respective score for each of the predicted classes, and one or more regressed keypoints associated with the locations on the three-dimensional model of the object.

16. The method of claim 15, wherein at least the portion of the one or more candidate bounding boxes are sampled from the one or more candidate bounding boxes based on respective objective function scores.

17. The method of claim 14, wherein the machine learning model comprises a single stage neural network, wherein the single stage neural network is configured to receive as input the image and one or more sparse keypoints determined for the object in the image, and is configured to generate output that, for the input image, includes at least a predicted class for each input bounding box, a respective score for each of the predicted classes, and one or more regressed keypoints associated with the locations on the three-dimensional model of the object.

18. A computer-implemented method, comprising:
receiving data representing an image capturing an object, wherein the object has a physical pose represented in the image;
receiving data representing a predicted pose of the object;
determining a plurality of image features including gradients and magnitudes in multiple channels of the image;
determining a plurality of candidate features for the object based on the data representing the predicted pose of the object;
for each of the plurality of candidate features, selecting, according to one or more criteria, an image feature of the plurality of image features that corresponds to the candidate feature to generate a pair of features including the candidate feature and the selected image feature, and
updating the predicted pose of the object based on the pairs of feature.

19. The method of claim 18, wherein the plurality of candidate features comprise one or more local maxima model gradients of multiple modalities.

20. The method of claim 18, wherein the one or more criteria comprise at least one of: an image feature being a local maximum in a gradient direction, a threshold difference in a direction between a candidate feature and an image feature, or a threshold difference in magnitude between an image feature and a maximum of the candidate feature along a search line.
